(19) United States
(12) Patent Application Publication
(10) Pub. No.: US 2026/0113206 A1
(43) Pub. Date: Apr. 23, 2026

(54) SYSTEMS AND METHODS TO ESTABLISH DEVICE IDENTITY AND TRUST USING PASSKEYS

(71) Applicant: Mastercard International Incorporated, Purchase, NY (US)

(72) Inventors: Ameya Vinayak Sohoni, Pune (IN); Kaushal Shetty, Thane (W) Maharashtra (IN); Mayank Joshi, Pune (IN)

(21) Appl. No.: 18/919,826

(22) Filed: Oct. 18, 2024

(51) Int. Cl. H04L 9/32; H04L 9/08; H04L 9/30

(52) U.S. Cl. CPC H04L 9/3271; H04L 9/0866; H04L 9/0894; H04L 9/30

(57) ABSTRACT

Systems, methods, apparatus and computer program code are provided to receive, from a first user device, a request to register the first user device as a primary user device of a user account at the server, the request including a public key generated by the first user device, determine that the request to register is approved, store, in a secure storage device, a device mapping data record, the device mapping data record including a unique identifier, information identifying the first user device and information designating the first user device as a primary user device of the user account, store the public key in the secure storage device and associating the public key with the user account, and transmit the unique identifier to the first user device in a registration success response.

### BACKGROUND

Fast Identity Online (FIDO) is a set of standards designed to enhance online authentication by providing a secure, fast, and user-friendly alternative to traditional passwords. Developed by the FIDO Alliance, FIDO aims to address the weaknesses and challenges associated with passwords, such as their vulnerability to phishing, credential stuffing, and other forms of attacks.

In general FIDO uses public key cryptography to support password-less authentication, using which users can enable their trusted devices to act as the primary form of authentication to access relying party resources. This reduces the dependency on remembering passwords and allows the user to have a seamless login experience. Users can use an “authenticator” available on their devices to provide the user authentication (e.g., using biometrics such as Face ID on an Apple device). FIDO was originally designed to work on single devices (where the credentials would never leave a specific device on which it was registered). Recently, there have been attempts to extend FIDO to allow multi device credentials where credentials registered on a device may be shared with other devices by synchronizing the credentials (e.g., using a passkey server or credential provider) across different devices. In this way, secondary devices can be used to access the user’s account at the FIDO server.

However, because both devices share the same digital credential (cryptographic private key), the FIDO server is unaware of which device is accessing the user account. As such, what is needed is a way to distinguish commonly owned devices for a user account when accessing a FIDO server.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an existing process of synchronizing credentials across user devices using a FIDO server.

FIG. 2 is a diagram illustrating process of registering a primary device pursuant to some embodiments.

FIG. 3 is a diagram illustrating an authentication process using a primary device pursuant to some embodiments.

FIG. 4 is a diagram illustrating a process for registering and using a secondary user device pursuant to some embodiments.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Pursuant to some embodiments, systems, methods, apparatus and computer program code are provided to securely perform user authentication with multiple user devices. Embodiments enable the secure identification of which device of multiple devices is using a credential to obtain access to a service as well as the secure identification of how and where the credential is being used. Processing, in some embodiments, includes an initial device registration process that includes receiving, from a first user device, a request to register the first user device as a primary user device of a user account at the server, the request including a public key generated by the first user device, determining that the request to register is approved, storing, in a secure storage device, a device mapping data record, the device mapping data record including a unique identifier, information identifying the first user device and information designating the first user device as a primary user device of the user account, storing the public key in the secure storage device and associating the public key with the user account, and transmitting the unique identifier to the first user device in a registration success response.

Pursuant to some embodiments, once a primary device has been registered, the primary device may be used to perform authentication processes by transmitting the unique identifier in conjunction with a challenge object and signing both the unique identifier and the challenge object using the private key.

Pursuant to some embodiments, once a primary device has been registered, one or more secondary devices may be registered for use with the user account. Embodiments securely share or synchronize the private key generated by the first device with the secondary devices using, e.g., a cloud passkey manager. The secondary devices may be used to perform authentication processing associated with the user account after registration and after a unique identifier has been established associating each secondary device with the user account. In this manner, embodiments enable the secure identification of which device of multiple devices is using a credential to obtain access to a service as well as the secure identification of how and where the credential is being used.

Prior to describing features of some embodiments by reference to the figures, an illustrative example will first be introduced. In the example, a hypothetical user (“Tom”) has an account (a “user account”) at a financial institution. Tom wants to use his mobile phone (a “user device”) to access the account. Tom’s mobile phone is a Apple iPhone®, and Tom uses Apple’s iCloud Keychain to store his passwords and credentials. Using features of the present invention Tom may register his mobile phone as his primary device to access the account. The registration includes Tom interacting with an application on his mobile phone to first authenticate himself to his mobile device (e.g., using biometrics or the like) and then to generate an asymmetric key pair (a private key and a corresponding public key). The key pair is securely generated by his mobile device and the keys are securely stored on the mobile device. The mobile device then interacts with an identity server to exchange information so that the identity server may validate the integrity of the information received from the mobile device and to receive the public key. The identity server then stores information about Tom, the mobile device, and the public key in secure storage (e.g., in a device mapping table and a key mapping table, as discussed further below).

Tom’s iPhone is identified as Tom’s “primary” device and a unique identifier is assigned to the device and stored in the device mapping table. The unique identifier is transmitted to the mobile device for use in subsequent authentication transactions. Tom may now use his iPhone (his “primary device”) to access his user account. Also, if Tom wishes to use one or more different user devices (e.g., a different phone, or a different computer) to access the account, those devices may be registered as “secondary devices”. As will be discussed further below, to register those secondary devices, the private key generated by Tom’s primary device will be securely shared with the secondary device(s) and a similar registration process will be performed for each of the secondary devices, with an added step of a confirmation message that will be sent from the identity server to Tom’s primary device which allows Tom to confirm (or decline) to associate the secondary devices to his user account. Registration includes assigning a new unique identifier to each secondary device and adding information about each device to the device mapping table. Once registered, each secondary device may be used to perform authentications. These registration steps and the assignment and tracking of unique identifiers for each primary and secondary device enable the secure identification of which device of multiple devices is using a credential to obtain access to a service as well as the secure identification of how and where the credential is being used.

The example embodiments described herein are implemented using the fast identity online (“FIDO”) authentication protocols that replace passwords with a more secure and convenient login process. The FIDO authentication protocols are published by the FIDO Alliance and are available at https://www.fidoalliance.org.

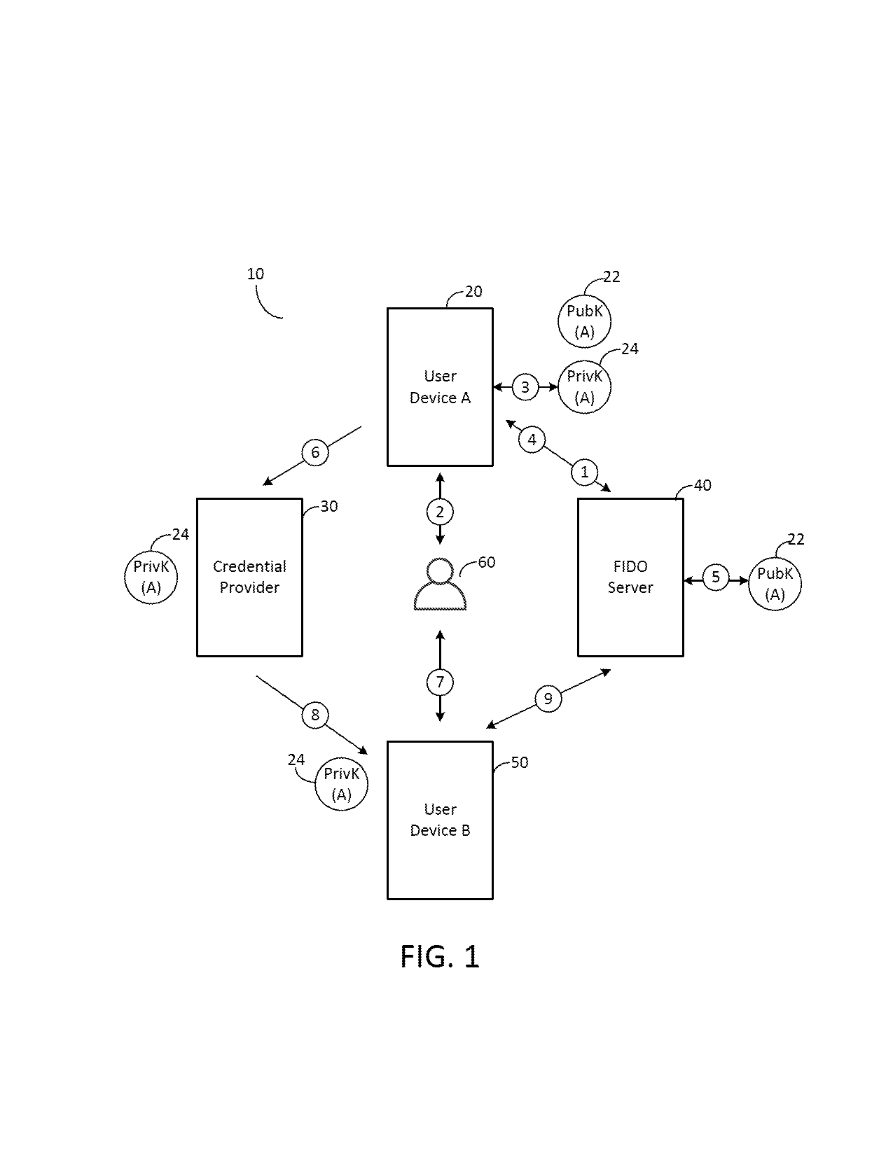

Features of some embodiments will now be described by reference to the figures. Reference is first made to FIG. 1, which depicts an example FIDO registration and authentication system 10 involving multiple user devices 20, 50 associated with a user 60. The system 10 may be operated to register a device 20 to allow the device 20 to be used in password-less authentication transactions associated with an account of the user 60 (the “user account”). In general, “fast identity online” is a public key cryptography concept developed to support password-less authentication which allows users to enable their trusted devices to act as the primary form of authentication to access so-called “relying party” resources. A “relying party” is an entity or service that requests authentication from a user and relies on the FIDO protocol to verify the user’s identity securely. For example, a relying party may be a bank or financial institution that relies on the FIDO protocol to verify account holder’s identity during transactions or interactions. The use of FIDO reduces the need for users to remember passwords and allows users to have a seamless login experience. In the example system 10 of FIG. 1, the FIDO protocol is being used to support multiple device credentials, where a user 60 who registers multiple devices 20, 50 can use either device to perform password-less authentication with a relying party. Unfortunately, the approach shown in FIG. 1 does not allow the relying party to distinguish which user device 20, 50 has been used in an authentication transaction, as both user devices 20, 50 share the same credentials.

This can be better understood by following several interaction flows (as depicted by the numbered arrows) of FIG. 1. The numbered arrows of FIG. 1 (and other figures herein) are not intended to illustrate all possible messages between devices; instead, they are provided to describe certain relevant messages of an interaction. In a first interaction flow, where the user 60 registers user device 20, the user 60 interacts with an application on the user device 20 to initiate a transaction with a relying party. Because the relying party is using the FIDO protocol, this interaction causes a FIDO server 40 (operated by or in communication with the relying party) to send a challenge message at (1) to the user device 20. The challenge message (1) may include a random string (or nonce) that is generated by the FIDO server 40. This random value ensures that each registration request is unique and helps prevent replay attacks. The challenge message (1) may include other data elements (such as an identifier of the relying party, etc.)

Upon receipt of the challenge message (1) by the user device 20, the user device 20 (under control of one or more application programs) prompts the user 60 to perform a user authentication process (2) (e.g., such as performing a biometric or other authentication factor). If the user 60 is authenticated by the user device 20, the user device 20 is controlled to generate an asymmetric key pair (including a public key 22 and a private key 24). The user device 20 stores these keys in a secure storage location on the user device 20 (e.g., such as a secure element or the like). The user device 20 is then controlled to transmit a response (4) to the challenge (1). The response (4) includes the public key 22 and the challenge (signed by the private key 24).

At (5) the FIDO server 40 receives the public key 22 and uses it to decrypt the signed challenge. If the decrypted signed challenge matches the original challenge, the FIDO server 40 considers the registration to be successful and returns a success response to the user device 20 and the user device 20 may be used in subsequent authentication transactions. The FIDO server 40 stores the public key 22 in association with the user account so that it can be used in those subsequent transactions.

In the multi-device approach shown in FIG. 1, if the user 60 wishes to use a second user device 50 as an authentication device with the same relying party, the following additional interactions occur. First, the private key 24 generated by the user device 20 is synchronized (6) to a credential provider 30 associated with the user 60 and the user devices 20, 50. For example, the credential provider 30 may be a passkey service such as Apple’s iCloud Keychain, Google’s Password Manager, or the like. When the private key 24 is synchronized (6) to the credential provider 30, the credential provider 30 securely stores the private key 24 in association with the user 60. When the user 60 operates the user device 50 to interact with the relying party, the credential provider 30 provides the private key 24 to the user device 50 for storage in a secure storage location. At this point, both user devices 20, 50 store the same private key 24 (as does the credential provider 30).

When the user 60 interacts with the user device 50 to access a service or account associated with the relying party, the user device 50 transmits a message authentication message (9) to the FIDO server 40 which includes a challenge signed by the private key 24. The FIDO server 40 identifies the public key 22 associated with the user (or user account) and validates that the signed challenge is correct and authenticates the user 60.

In this approach, because both user devices 20, 50 use the same private key 24 to sign the challenge, there is no information identifying which device was involved in the authentication. This lack of information presents an audit and control gap which can impact the security of transactions.

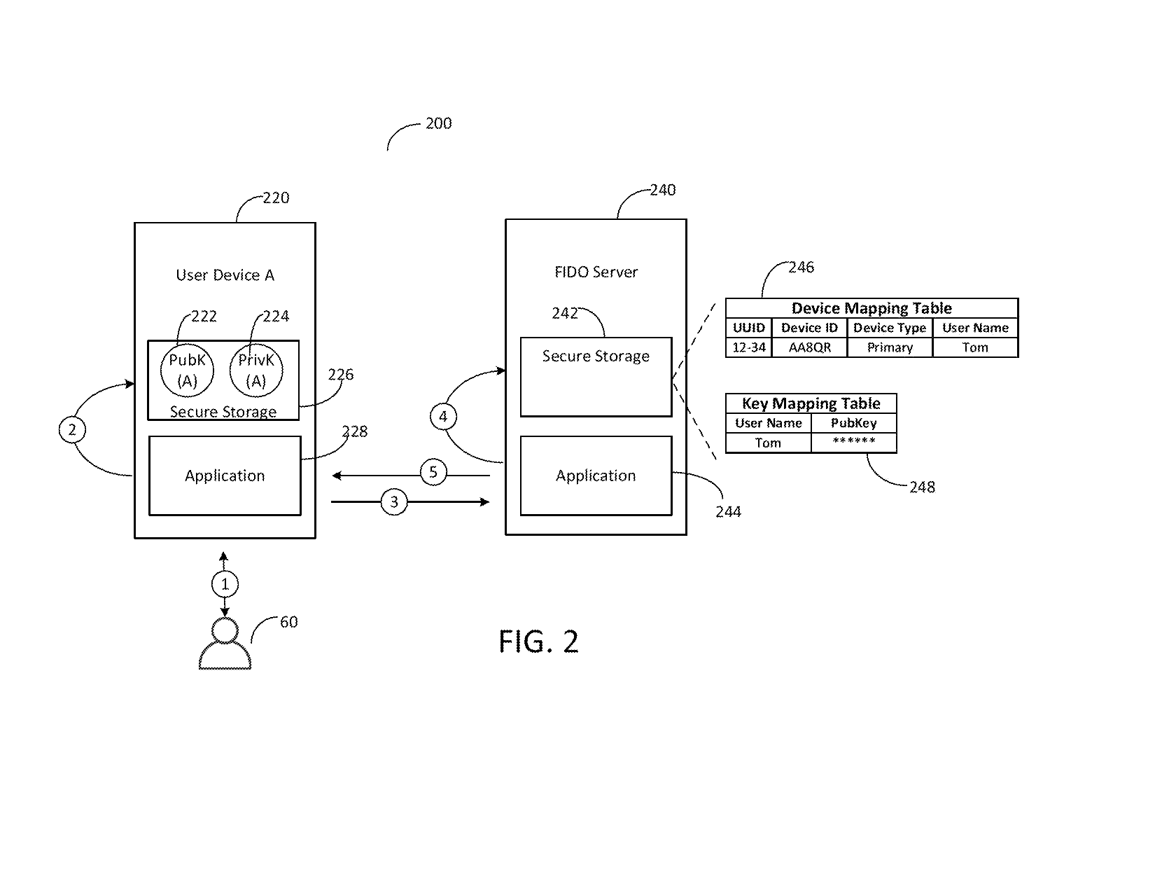

Reference will now be made to FIGS. 2-4 where an improved identity system 200 and processes are shown that enable the secure identification of which device of multiple devices using a credential to obtain access to a service as well as the secure identification of how and where the credential is being used. Referring first to FIG. 2, an identity system 200 is shown as well as a number of interactions which result in registration of a user device as an authentication device. Continuing the illustrative example introduced above, a user 60 (“Tom”) has a first user device 220 and wishes to register the first user device 220 to access an account (a “user account”) associated with a relying party (e.g., such as a financial institution or the like). The user 60 interacts with the first user device 220 to initiate an interaction with the relying party (e.g., by interacting with a Web page, an application or the like) which requires authentication of the user’s identity. In some embodiments, this may cause the invocation of code to validate the device integrity (e.g., by invoking a runtime application self-protection, or “RASP” library to detect if the user device 220 has been rooted or jailbroken or otherwise tampered with). If the device integrity is confirmed, a FIDO registration process may be invoked in which the user 60 is prompted to perform some form of user authentication (e.g., such as a biometric authentication). The user’s interaction with the relying party Web page or application initiates a FIDO registration process which causes a challenge to be created.

Upon successful user authentication, an application 228 on the first user device 220 interacts with the user device to generate (2) an asymmetric key pair including a public key 222 and a private key 224. These keys 222, 224 are stored in a secure storage 226 of the first user device 220. The application 228 then signs the FIDO challenge using the private key 224 and transmits a message (3) to the FIDO server 240 which includes an attestation object as well as the signed FIDO challenge and the public key 222. The FIDO server 240, upon receipt of this message, performs processing (4) to validate the signature on the signed challenge (using the public key 222) and validates the attestation object (e.g., to ensure that authentication preferences comply with the relying party organizational or security standards). If both are acceptable, the FIDO server 240 generates a uniform user identifier (“UUID”) for the user 60 and the first user device 220 and stores the information in secure storage 242. For example, the information may be stored in a table such as a device mapping table 246. In some embodiments, the information stored includes the newly generated UUID, a device identifier, a device type and the user name (although those skilled in the art will appreciate that additional items of information may be stored). In this case, since the first user device 220 is the first (and so far only) user device registered by the user 60, the device type may be indicated as “Primary” (or some similar identifier or label). The device identifier may be based on information received from the user device which may be used to uniquely identify or fingerprint the device.

The FIDO server 240 also stores the public key 222 and associates the public key 222 with the user 60. For example, as shown in FIG. 2, the public key 222 may be stored in a key mapping table 248 with an association to the device mapping table 246 (e.g., with the user name, for example, as the table relationship key).

The FIDO server 240 then transmits a response message (5) to the first user device 220. The response message (5) includes information including, for example, the UUID and a success response. In some embodiments, the UUID is transmitted encrypted using the public key 222. The first user device 220 stores the encrypted UUID in secure storage 226 for later use in authentication transactions with the relying party. In this manner, when the first user device 220 is used in authentication transactions associated with the user’s account, the FIDO server 240 is now able to identify which user device was involved in an authentication transaction.

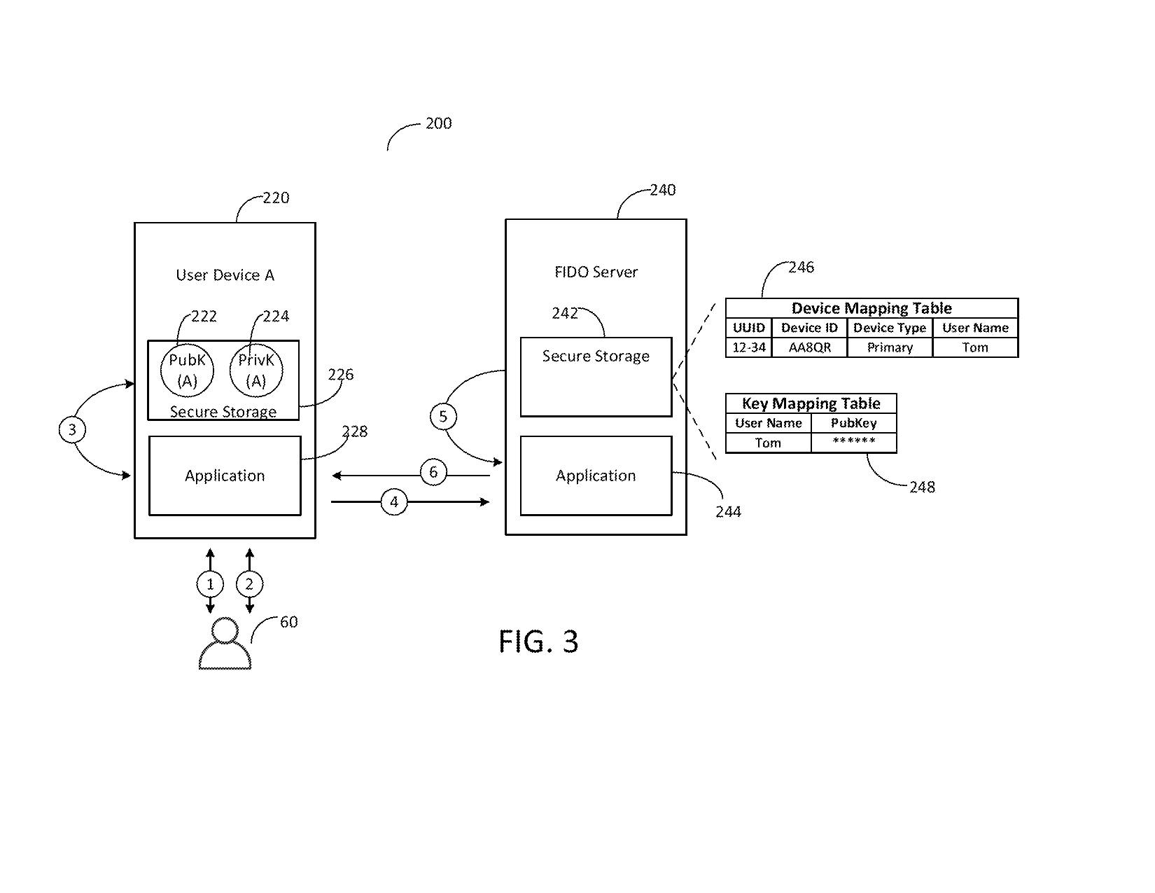

Reference is now made to FIG. 3 where the improved identity system 200 is shown operating to perform an authentication process using the first user device 220 (which is now the user’s primary device after performance of the registration process of FIG. 2). When the user 60 wishes to access a service or account associated with the relying party (the “user account”) for which the first user device 220 was registered in FIG. 2, the user 60 interacts (1) with a Web page or application using the first user device 220. As discussed above, because the relying party is using an authentication service pursuant to the present invention (which may be based on the FIDO protocol), this interaction (1) causes a FIDO server 240 to send a challenge message to the first user device 220. The challenge message may include a random string (or nonce) that is generated by the FIDO server 240. This random value ensures that the interaction is unique and helps prevent replay attacks. Upon receipt of the challenge message, the first user device 220 prompts the user 60 to perform a user authentication process (2) (e.g., such as performing a biometric or other authentication factor). If the user 60 is authenticated by the first user device 220, the first user device 220 is controlled (3) to unlock the private key 224 from secure storage 226. The first user device 220 uses the unlocked private key 224 to decrypt the UUID and generates a message (4) which includes an attestation object and an object signed by the private key 224 (which includes the challenge and the UUID). This message (4) is transmitted from the first user device 220 to the FIDO server 240.

Upon receipt of the message (4), the FIDO server 240 performs processing (5) to identify the public key 222 associated with the user 60 (by retrieving it from the key mapping table 248 in secure storage 242). The public key 222 is used to decrypt the object that includes the challenge and the UUID. If a UUID is present in the message (3), the first user device 220 is “known” to the FIDO server 240 and a normal authentication process is performed by the FIDO server 240 (e.g., where the FIDO server 240 validates the signature of the signed challenge, confirms that the attestation object matches the relying party’s requirements, and returns an authentication successful response (6) to the first user device 220). If a UUID is not present in the message (3) the FIDO server 240 determines that the first user device 220 is “unknown”, and the FIDO server 240 performs processing to register the first user device 220 (e.g., as described in conjunction with FIG. 2). In this example, however, the first user device 220 is known to the FIDO server 240, and the authentication process concludes with the transmission (6) of an authentication successful response to the first user device 220 and the first user device 220 (and the user 60) have access to the resource associated with the relying party. The FIDO server 240 may maintain an audit trail or other information tracking which specific user device requested and obtained the access, allowing improved security and control of the transaction.

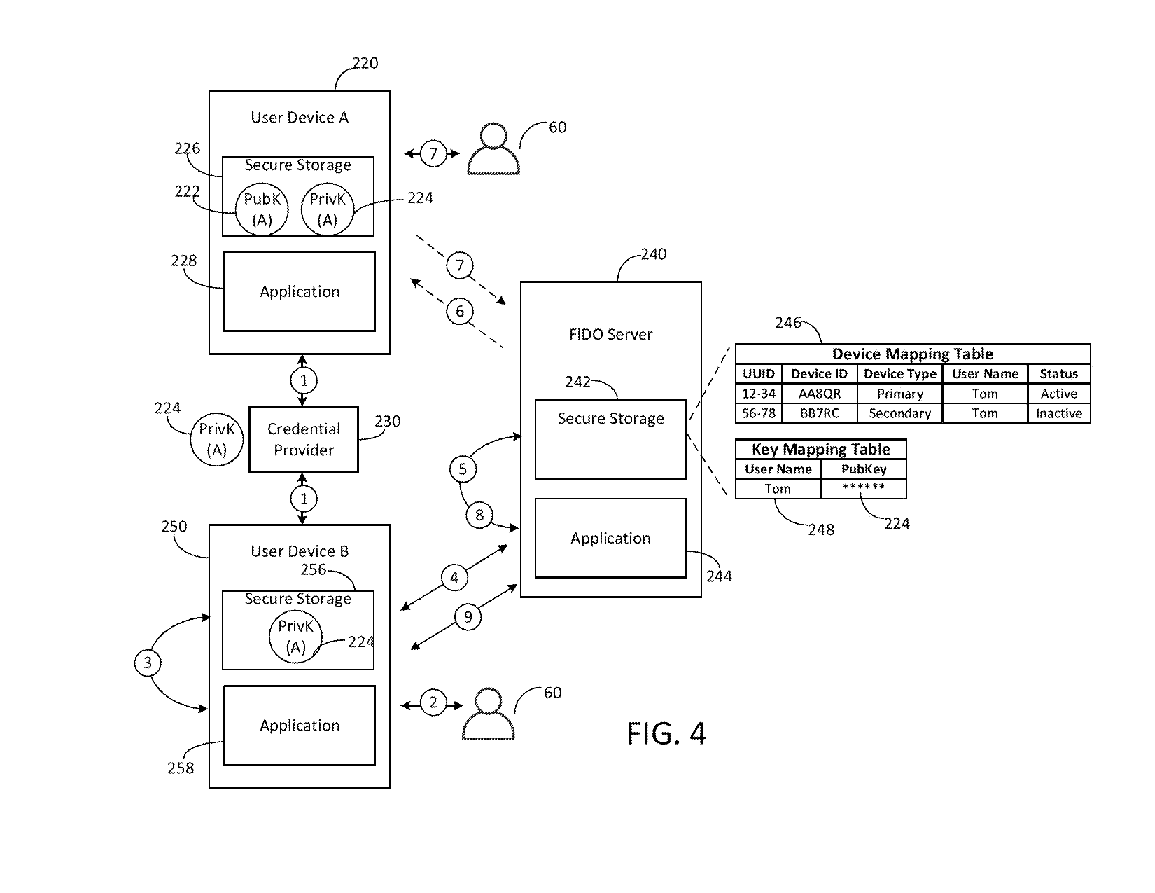

Reference is now made to FIG. 4, where the improved identity system 200 is shown operating to register (and use) a second user device 250 of the user 60. The second user device 250 may be another mobile phone, a laptop or desktop computer, or the like that is owned or controlled by the user 60 and which the user 60 wishes to operate as an authentication device for access to a user account associated with the relying party. The user 60 has already registered the first user device 220 as his “primary” user device associated with his account (as described above in conjunction with FIG. 2). Now, the user 60 wishes to access his user account with relying party using a second user device 250. The registration of the second user device 250 begins at (1) where a credential provider 230 (e.g., such as a passkey service such as Apple’s iCloud Keychain, Google’s Password Manager, or the like) is operated to synchronize the private key 224 generated by the first user device 220 (e.g., in the transaction described in FIG. 2) to the secure storage 256 of the second user device 250. The credential provider 230 may store the private key 224 for later synchronization with other user devices associated with the user 60. At this point, both the first user device 220, the second user device 250 and the credential provider 230 securely store the private key 224.

Processing continues at (2) where the user 60 interacts with the second user device 250 to access a service or account associated with the relying party. The user 60 interacts with the second user device 250 to initiate an interaction with the relying party (e.g., by interacting with a Web page, an application, or the like) which requires authentication of the user’s identity. In some embodiments, this may cause the invocation of code to validate the device integrity (e.g., by invoking a runtime application self-protection, or “RASP” library to detect if the second user device 250 has been rooted or jailbroken or otherwise tampered with). If the device integrity is confirmed, a FIDO registration process may be invoked in which the user 60 is prompted to perform some form of user authentication (e.g., such as a biometric authentication). The user’s interaction with the relying party Web page or application initiates a FIDO registration process which causes a challenge to be created by the FIDO server 240. The challenge is provided to the second user device 250.

At (3), the second user device 250 operates to retrieve the private key 224 from secure storage 256 and uses the private key 224 to sign the challenge, and at (4) transmits the signed challenge as well as an attestation object to the FIDO server 240. At (5) the FIDO server 240 retrieves the public key 224 from secure storage 242 and uses the public key 224 to decrypt the signed challenge to validate that the second user device 250 did indeed possess the correct private key 224. The FIDO server 240 also compares the attestation object to the relying party’s authenticator preferences to confirm they comply with the relying party’s requirements. At this point, the FIDO server 240 may check whether a UUID was received from the second user device 250. If a UUID was received, processing would proceed as shown in FIG. 3 (because the second user device 250 would have previously been registered, that is, is “known”). However, in this example, the second user device 250 did not have a UUID (e.g., is “unknown”) and therefore processing by the FIDO server 240 proceeds to attempt to make the second user device 250 known.

The FIDO server 240 performs processing to initiate a new device registration against the already known user 60. This includes processing to identify the primary device associated with the user 60 by performing a lookup of the device mapping table 246. Once the primary device is identified (here, the first user device 220), the FIDO server 240 generates a UUID for the device being registered (here, the second user device 250) and encrypts it using the public key 224 (retrieved from the key mapping table 248). FIDO server 240 sends an out-of-band notification message (6) to the primary device (here, the first user device 220) requesting the user 60 to authorize the new device (the second user device 250) for use as a multi-device credential device. The “out-of-band” message is transmitted in a second channel. For example, the message (6) may be transmitted as a push notification to the first user device 220. The user 60, upon receiving the message, either approves or denies the use of the second user device 250 as an authentication device and transmits the approval or denial at (7) over the out-of-band transmission channel.

At (8), the FIDO server 240 receives the response message (7) from the first user device 220. If the response is an approval, the FIDO server 240 validates the signed UUID using the public key 224 and updates the device mapping table 246 with a new entry for the second user device 250 (including the UUID generated for the second user device 250, a type of the second user device 250, the user name, and a status of the second user device 240). In some embodiments, the entry for the second user device 250 may be created before transmission of message (6) and may be set as “inactive” until an affirmative response (7) is received from the user 60 (when it is set to “active”).

At (9), the FIDO server 240 transmits an authentication success message to the second user device 250. The authentication success message (9) includes the encrypted UUID assigned to the second user device 250. The second user device 250 stores the encrypted UUID for use in subsequent transactions. At this point, the second user device 250 may be used in authentication transactions with the FIDO server 240 (e.g., the second user device 250 may be used in the transaction described in FIG. 3). Each time the second user device 250 (or the first user device 220) is used in an authentication transaction, the FIDO server 240 is able to determine, log and track which specific device was used for the authentication transaction, thereby improving the overall security of the system.

While two user devices 220 and 250 have been described, those skilled in the art, upon reading the present disclosure, will appreciate that any number of user devices may be registered by a user 60 and used in transactions as described herein (and each of the uses of those devices will be identifiable and associated with the respective device involved). Further, while a single FIDO server 240 and credential provider 230 have been described, in practice, a number of different such devices may be used by different relying parties to secure access to accounts and services.

The credential provider 230 may be configured to automatically synchronize passkeys that are held on a first user device across one or more other user devices that are registered by the user.

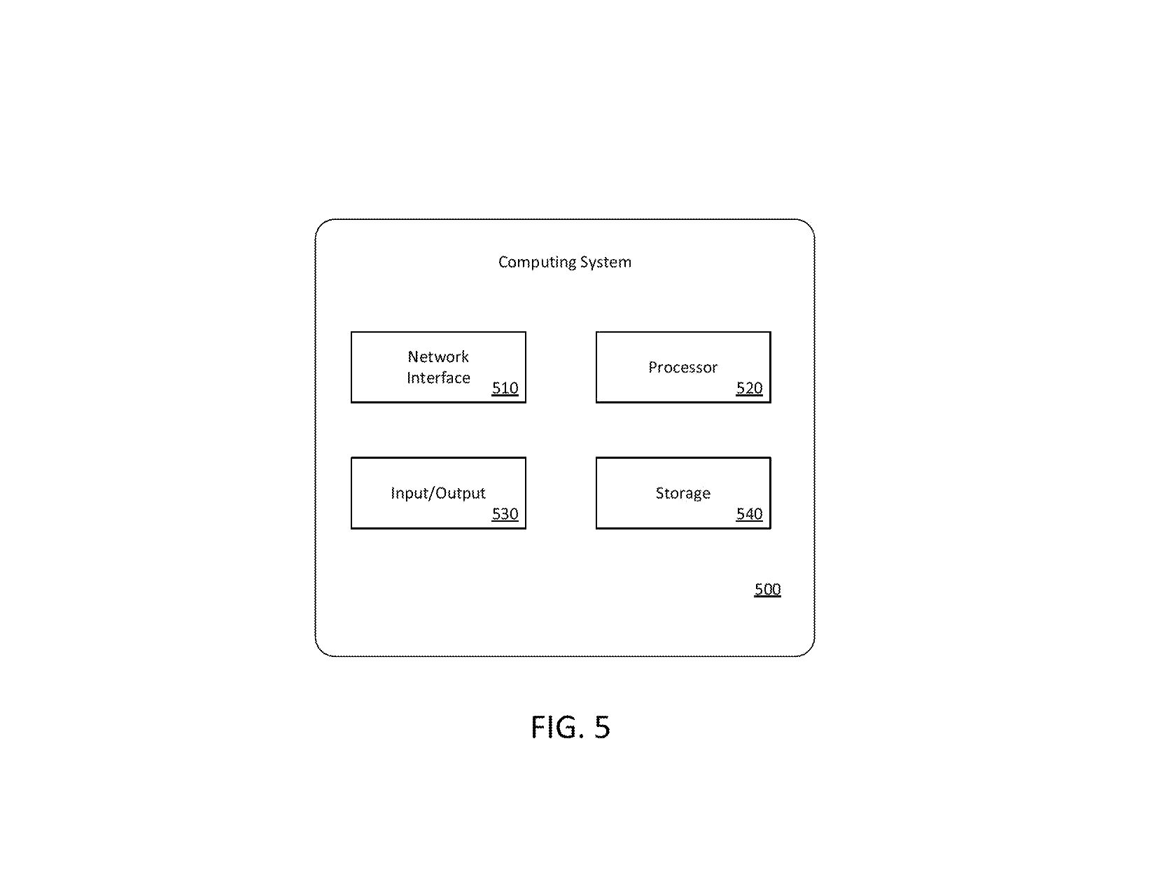

FIG. 5 illustrates a computing system 500 that may be used in any of the methods and processes described herein, in accordance with an example embodiment. For example, the computing system 500 may be a mobile device, a server, a cloud platform, a payment network system, a merchant computer, or the like. In some embodiments, the computing system 500 may be distributed across multiple computing devices. Referring to FIG. 5, the computing system 500 includes a network interface 510, a processor 520, an input / output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control or replace the other components of the computing system 500.

The network interface 510 may transmit and receive data over a network such as the Internet, a private network, a public network, a payment network, an enterprise network, and the like. The network interface 510 may include a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input / output 530 may include an interface, a port, a cable, a bus, a board, a wire, and the like, for inputting and outputting data to and from the computing system

500. For example, data may be output to an embedded display of the computing system 500, an externally connected display, a display connected to the cloud, another device, and the like. The network interface 510, the input / output 530, the storage device 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage device 540 may store software modules or other instructions which can be executed by the processor 520 to perform the methods described herein.

As an example, the processor 520 may register a first user device as a primary user device of a user account at a FIDO server. In this example, the processor 520 may receive a public key generated by the first user device from the first user device and store the public key in the storage device 540. The processor 520 may also receive a registration request for the user account from a second user device, wherein the registration request includes information signed with a private key generated by the first user device. The processor 520 may verify the signature of the information using the public key stored in the storage device 540. Furthermore, in response to the verification, the processor 520 may register the second user device as a secondary user device of the user account at the FIDO server.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable medium / media, thereby making a computer program product, i.e., an article of manufacture, according to the discussed examples of the disclosure. For example, the non-transitory computer-readable medium may be, but is not limited to, a fixed drive, diskette, optical disk, magnetic tape, flash memory, external drive, semiconductor memory such as read-only memory (ROM), random-access memory (RAM), and/or any other non-transitory device or system.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program, apparatus, cloud storage, and/or device (e.g., magnetic discs, optical disks, memory, programmable logic devices (PLDs)) used to provide machine instructions and/or data to a programmable processor, including a non- transitory machine-readable medium that receives machine instructions as a machine-readable signal. The “machine-readable medium” and “computer-readable medium,” however, do not include transitory signals.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. An identity server, comprising:
a storage device; and
a processor configured to
receive, from a first user device, a request to register the first user device as a primary user device of a user account at the server, the request including a public key generated by the first user device;
determine that the request to register is approved;
store a device mapping data record in the storage device, the device mapping data record including a unique identifier, information identifying the first user device and information designating the first user device as a primary user device of the user account;
store the public key in the storage device and associate the public key with the user account; and
transmit the unique identifier to the first user device in a registration success response.

2. The server of claim 1, wherein the request to register further includes an attestation object and a signed challenge, the challenge signed by a private key of a key pair generated by the first user device.

3. The server of claim 1, wherein determining that the request to register is approved further comprises operating the processor to:
validate the challenge signed by the private key using the public key; and
validate the attestation object.

4. The server of claim 1, wherein the processor is further configured to:
receive an authentication request from the first user device, the authentication request including an attestation object and an object signed by the private key of the first user device, the object including a challenge and the unique identifier;
extract the challenge and the unique identifier from the object using the public key associated with the user account;
determine that the unique identifier is associated with the user account; and
transmit an authentication success response to the first user device.

5. The server of claim 1, wherein the processor is further configured to:
receive an authentication request for the user account from a second user device, the authentication request including an attestation object and a challenge signed by the private key generated by the first user device;
validate the challenge signed by the private key using the public key associated with the user account;
identify the primary user device associated with the user account in the device mapping table;
transmit an out-of-band notification to the primary user device requesting an authorization to associate the second user device with the user account; and
upon receipt of a response to the out-of-band notification, storing a further device mapping data record in the storage device, the further device mapping data record including a second unique identifier, information identifying the second user device and information designating the second user device as a secondary device of the user account.

6. The server of claim 5, wherein the processor is further configured to:
encrypting the second unique identifier using the public key associated with the user account and transmitting the encrypted second unique identifier to the second user device.

7. The server of claim 5, wherein the private key generated by the first user device is securely provided to the second user device via a cloud passkey manager.

8. The server of claim 1, wherein the processor is further configured to:
receive an authentication request for the user account from a second user device, the authentication request including an attestation object and an object signed by the private key of generated by the first user device, the object including a challenge and a second unique identifier;
extract the challenge and the second unique identifier from the object using the public key associated with the user account;
determine that the second unique identifier is associated with the user account; and
transmit an authentication success response to the second user device.

9. The server of claim 1, wherein the server is configured to operate as a fast identity online (“FIDO”) server.

10. A method, comprising:
receiving, from a first user device, a request to register the first user device as a primary user device of a user account at the server, the request including a public key generated by the first user device;
determining that the request to register is approved;
storing, in a secure storage device, a device mapping data record, the device mapping data record including a unique identifier, information identifying the first user device and information designating the first user device as a primary user device of the user account;
storing the public key in the secure storage device and associating the public key with the user account; and
transmitting the unique identifier to the first user device in a registration success response.

11. The method of claim 10, wherein the request to register further includes an attestation object and a signed challenge, the challenge signed by a private key of a key pair generated by the first user device.

12. The method of claim 11, wherein determining that the request to register is approved further comprises:
validating the challenge signed by the private key using the public key; and
validating the attestation object.

13. The method of claim 10, further comprising:
receiving an authentication request from the first user device, the authentication request including an attestation object and an object signed by the private key of the first user device, the object including a challenge and the unique identifier;
extracting the challenge and the unique identifier from the object using the public key associated with the user account;
determining that the unique identifier is associated with the user account; and
transmitting an authentication success response to the first user device.

14. The method of claim 10, further comprising:
receiving an authentication request for the user account from a second user device, the authentication request including an attestation object and a challenge signed by the private key generated by the first user device;
validating the challenge signed by the private key using the public key associated with the user account;
identifying the primary user device associated with the user account in the device mapping table;
transmitting an out-of-band notification to the primary user device requesting an authorization to associate the second user device with the user account; and
upon receipt of a response to the out-of-band notification, storing a further device mapping data record in the secure storage device, the further device mapping data record including a second unique identifier, information identifying the second user device and information designating the second user device as a secondary device of the user account.

15. The method of claim 14, further comprising:
encrypting the second unique identifier using the public key associated with the user account and transmitting the encrypted second unique identifier to the second user device.

16. The method of claim 14, wherein the private key generated by the first user device is securely provided to the second user device via a cloud passkey manager.

17. The method of claim 10, further comprising:
receiving an authentication request for the user account from a second user device, the authentication request including an attestation object and an object signed by the private key of generated by the first user device, the object including a challenge and a second unique identifier;
extracting the challenge and the second unique identifier from the object using the public key associated with the user account;
determining that the second unique identifier is associated with the user account; and
transmitting an authentication success response to the second user device.

18. The method of claim 10, wherein the method is performed by a fast identity online (“FIDO”) server.
